(19) United States
(12) Patent Application Publication
(10) Pub. No.: US 2025/0135824 A1
(43) Pub. Date: May 1, 2025

(54) VARIABLE RATE SPRING

(71) Applicant: The Dynamic Engineering Solution Pty Ltd, Holden Hill, South Australia (AU)

(72) Inventor: Max O'Connell, Holden Hill, South Australia (AU)

(21) Appl. No.: 18/835,489

(22) PCT Filed: Feb. 2, 2023
(86) PCT No.: PCT/AU2023/050065

§ 371 Date: Aug. 2, 2024

(30) Foreign Application Priority Data
Feb. 2, 2022 (AU) 2022900198

(51) Int. Cl. B60G 11/58; B60G 15/06; B60G 15/12; B60G 17/027; B60G 17/033; B60G 17/04

(52) U.S. Cl. CPC B60G 11/58; B60G 15/065; B60G 15/12; B60G 17/0272; B60G 17/033; B60G 17/0416; B60G 2202/154; B60G 2202/24; B60G 2202/32; B60G 2202/413; B60G 2202/414; B60G 2204/62; B60G 2500/206; B60G 2800/162; B60G 2800/916

(57) ABSTRACT

A spring assembly for mounting between a chassis and an unsprung mass of a vehicle, the spring assembly comprising a coil spring and a hydropneumatic spring acting in series, wherein the hydropneumatic spring is configured to be switchable between a compressible state and an incompressible state, such that when the hydropneumatic spring is in the compressible state, the equivalent spring rate of the spring assembly is a function of the spring rate of the coil spring and the hydropneumatic spring, and when the hydropneumatic spring is in the incompressible state, the equivalent spring rate of the spring assembly is a function of the spring rate of the coil spring.

### PRIORITY DOCUMENTS

The present application claims priority from Australian Provisional Patent Application No. 2022900198 titled “VARIABLE RATE SPRING” and filed on 2 Feb. 2022, the content of which is hereby incorporated by reference in its entirety.

### TECHNICAL FIELD

The present invention relates to a spring assembly for a vehicle. In a particular form the present invention relates to a spring assembly for a vehicle with a switchable spring rate.

### BACKGROUND

A typical vehicle suspension arrangement comprises a damper and spring acting between the chassis and the unsprung mass of the vehicle.

Depending on the use of the vehicle, it may be desirable to change the spring rate of the spring. For instance, passenger vehicles will typically place a priority on driver and passenger comfort by providing a softer spring. However, if the vehicle is to be used for more spirited purposes, for instance, if it is being driven at a race track or on country roads, the priority may become the handling of the vehicle, which may be improved by providing a stiffer spring.

In order to achieve changes in spring rate, some suspension arrangements will require that coil springs be changed. Other arrangements may use air suspension, also known as air bags, where the pressure in the air bag is increased or decreased in order to increase or decrease the spring rate. The consequence of such a system is that the ride height of the vehicle is also adjusted, which may not always be desirable.

It is against this background that the present disclosure has been developed.

### SUMMARY

According to a first aspect, there is provided a spring assembly for mounting between a chassis and an unsprung mass of a vehicle, the spring assembly comprising a coil spring and a hydropneumatic spring acting in series, wherein the hydropneumatic spring is configured to be switchable between a compressible state and an incompressible state, such that when the hydropneumatic spring is in the compressible state, the equivalent spring rate of the spring assembly is a function of the spring rate of the coil spring and the hydropneumatic spring, and when the hydropneumatic spring is in the incompressible state, the equivalent spring rate of the spring assembly is a function of the spring rate of the coil spring.

In one form, the hydropneumatic spring comprises a hydraulic actuator in fluid communication with a hydraulic accumulator comprising a compressible volume of gas.

In one form, the hydraulic actuator comprises an actuator cylinder and an actuator piston configured to move within the actuator cylinder in compression and rebound, wherein the actuator cylinder is filled with a hydraulic fluid and is in fluid communication with the hydraulic accumulator.

In one form, the actuator cylinder is in selective fluid communication with the hydraulic accumulator by virtue of a switching valve, wherein the switching valve is switchable between an open and closed state, corresponding to the compressible and incompressible state of the second spring.

In one form, the spring assembly further comprises a third spring configured to act in parallel to the first and second spring acting in series.

According to a second aspect, there is provided a suspension strut for mounting between a chassis and an unsprung mass of a vehicle, the strut comprising a hydraulic damper, comprising a damper cylinder, a damper piston slidably retained within the damper cylinder and a piston rod for driving the piston within the damper cylinder in compression and rebound, the strut further comprising a spring assembly as described above, attached with respect to the damper cylinder at a first end, and to the piston rod at a second end.

### BRIEF DESCRIPTION OF DRAWINGS

Embodiments of the present invention will be discussed with reference to the accompanying drawings wherein:

FIG. 1 is a schematic of a spring assembly for a vehicle, according to an embodiment; and

FIG. 2 is a cross sectional view of an upper portion of a suspension strut incorporating the spring assembly that is schematically illustrated in FIG. 1.

### DESCRIPTION OF EMBODIMENTS

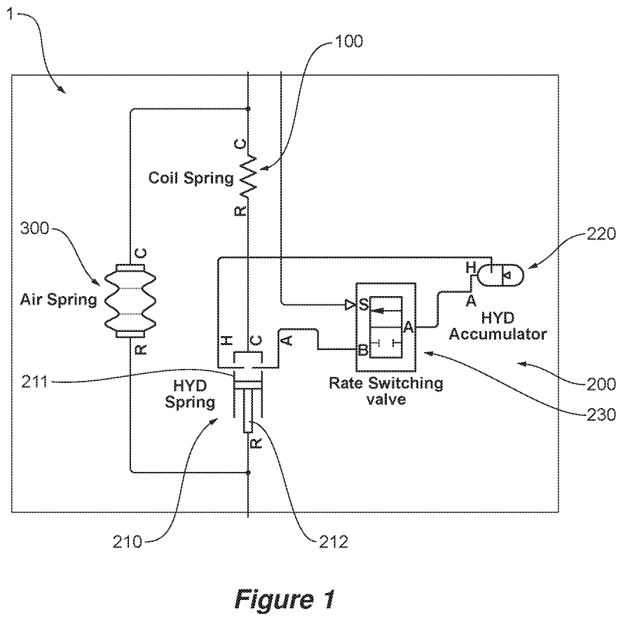

Referring now to FIG. 1, there is shown a schematic of a spring assembly 1 for mounting between the chassis and an unsprung mass of a vehicle, according to an embodiment. The assembly 1 comprises a switchable dual rate spring comprising a first and a second spring 100, 200 acting in series, where the second spring 200 is configured to be switchable between a compressible state, and an incompressible state.

It will be appreciated that the result of this arrangement is that when the second spring 200 is in a compressible state, the equivalent spring rate of the two springs in series is a function of the spring rate of the first and second spring 100, 200, defined by the below formula, where k_{eq} is the equivalent spring rate, k₁ is the spring rate of the first spring and k₂ is the spring rate of the second spring:

$${k}_{e q} = \frac{{k}_{1} \times {k}_{2}}{{k}_{1} + {k}_{2}} \qquad Equation 1$$

When the second spring 200 is in an incompressible state, the spring rate of the dual rate spring is effectively the same as the spring rate of the first spring 100.

By virtue of the above arrangement, it will be appreciated that the spring assembly 1 is able to operate at two different spring rates, such as a higher target spring rate associated with “track mode” and a lower target spring rate associated with “comfort mode”. The track mode spring rate corresponds to the spring rate of the first spring 100, and the comfort mode spring rate is achieved by appropriately sizing or setting the spring rate of the second spring 200.

For example, if the target spring rate for track mode was 40 N/mm and the target spring rate for comfort mode was 20 N/mm, a first spring 100 having a spring rate of 40 N/mm and a second spring 200 having a spring rate of 40 N/mm would be selected.

As can be seen in FIG. 1, the first spring 100 is a coil spring, and the second spring 200 comprises a hydraulic actuator 210 in fluid communication with a hydraulic accumulator 220 comprising a compressible volume of gas.

It can further be seen that the hydraulic actuator 210 comprises an actuator cylinder 211 and an actuator piston 212 configured to move within the actuator cylinder 211 in compression (also known as bump) and rebound (also known as extension). The actuator cylinder 211 is filled with a hydraulic fluid, and is in fluid communication with the hydraulic accumulator 220. It will be appreciated that when the actuator 210 moves in compression, the actuator piston 212 displaces hydraulic fluid from the actuator cylinder 211, causing compression of the volume of gas in the accumulator 220, resulting in an increase in the gas pressure within the accumulator. It will be appreciated that when the actuator 210 moves in rebound, the volume of gas in the accumulator 220 will expand, causing hydraulic fluid to flow back in to the actuator cylinder 211, and the actuator piston 212 to move in rebound.

The actuator cylinder 211 is in selective fluid communication with the hydraulic accumulator 220 by virtue of a switching valve 230. The switching valve 230 is switchable between an open and closed state, providing the compressible and incompressible state of the second spring 200 respectively. It will be appreciated that when the switching valve 230 is open, the accumulator 220 and cylinder 211 are in fluid communication and the volume of gas in the accumulator 220 is able to compress and expand, in response to movement of the actuator piston 212 with respect to the actuator cylinder 211, and when the switching valve 230 is closed, the accumulator 220 and cylinder 211 are not in fluid communication, preventing movement of the actuator piston 212 with respect to the actuator cylinder 211.

It will be appreciated that the compressible volume of gas in the accumulator 220 acts as an air spring, having a progressive spring rate, where it delivers higher pressures, and therefore higher spring rates, the further the volume is compressed.

As can also be seen in FIG. 1, the spring assembly 1 may also comprise an optional third spring 300 in the form of a variable volume air spring configured to act in parallel with the dual rate spring in order to adjust the ride height of the vehicle. It will be appreciated that the air spring also acts as a progressive spring, that delivers higher pressures, and therefore higher spring rates, the further the volume is compressed.

The equivalent spring rate of the third spring 300 acting parallel to the first 100 and second spring 200 acting in series is defined by the below formula, where k_{eq} is the equivalent spring rate, k₁ is the spring rate of the first spring 100, k₂ is the spring rate of the second spring 200 and k₃ is the spring rate of the third spring 300:

$${k}_{e q} = {k}_{3} + \frac{{k}_{1} \times {k}_{2}}{{k}_{1} + {k}_{2}} \qquad Equation 2$$

While in the embodiment shown, the third spring 300 is in the form of a variable volume air spring, it will be appreciated that alternate spring types may also be employed.

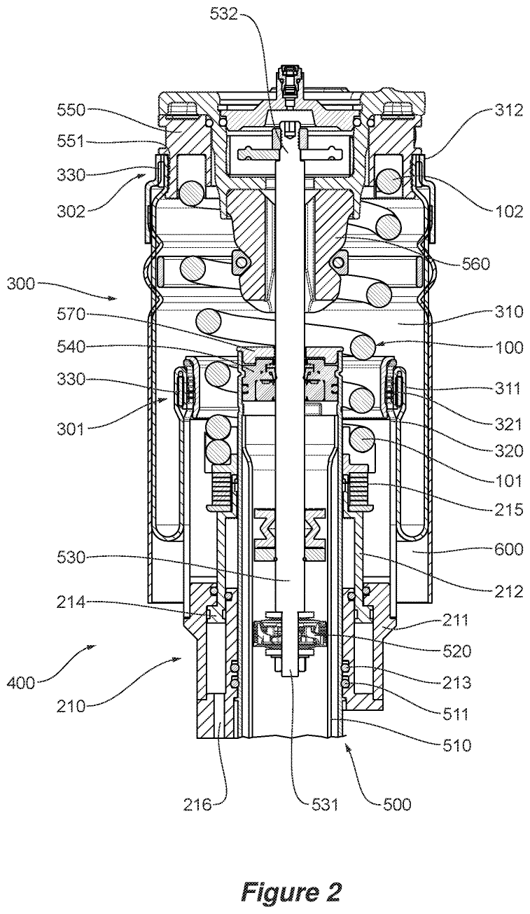

Referring now to FIG. 2, where there is shown a cross-sectional view of an upper portion of a suspension strut 400, according to an embodiment, for mounting between a chassis and an unsprung mass of a vehicle. The strut 400 comprises a hydraulic damper 500 comprising a damper cylinder 510, a damper piston 520 slidably retained within the damper cylinder 510 and a piston rod 530 for driving the piston 520 within the damper cylinder 510 in compression and rebound. The strut 400 further comprises a spring assembly 1 as described above attached with respect to the damper cylinder 510 at a first end and, to the piston rod 530 at a second end.

While in the embodiment shown, a monotube damper 500 is shown, it will be appreciated that alternative dampers could be employed without departing from the scope of this disclosure, such as twin-tube or remote reservoir dampers.

The spring assembly 1 is conceptually the same as that described above, however it will be appreciated that in this form, the various components are configured to locate around the outside of the hydraulic damper 500, such that the hydraulic actuator 210 has an annular form.

It can be seen that the actuator cylinder 211 has an annular form and is configured to locate over and be removably attached to the damper cylinder 510. An airtight seal is formed between the actuator cylinder 211 and the damper cylinder 510 by a pair of O-rings 511 disposed in grooves 213 formed in the central opening of the actuator cylinder 211. The actuator piston 212 has a cylindrical form and comprises a first portion 214 configured to move within the actuator cylinder 211 in compression and rebound, and a second portion 215 configured to extend out of the actuator cylinder 211 and provide a lower spring seat, against which a first end 101 of the coil spring 100 bears against. The second end 102 of the coil spring 100 bears against an upper spring seat 550, attached with respect to a second end 532 of the piston rod 530.

It will be appreciated that this support arrangement enables the coil spring 100 and hydraulic actuator 210 to act in series.

The actuator cylinder 211 comprises a conduit 216, providing passage for hydraulic fluid when the actuator cylinder 211 is in fluid communication with the accumulator 220.

The spring assembly 1 may also comprise a third spring in the form of an air spring 300 attached with respect to the damper cylinder 510 at a first end 301 and the piston rod 530 at a second end 302. It can be seen that the air spring 300 comprises an inflatable diaphragm 310, where the first end 311 of the diaphragm 310 is connected to a generally cylindrical rolling sleeve 320, where it is crimped between an engaging surface 321 on the rolling sleeve 320 and a crimping ring 330 to form an airtight seal. The rolling sleeve 320 is in turn connected to a portion of the actuator cylinder 211. It can be seen that the second end 312 of the diaphragm 310 is connected to the upper spring seat 550, where it is again crimped between an engaging surface 551 on the upper spring seat 550 and a crimping ring 330 to form an airtight seal.

While in the embodiment shown and described, the first and second ends 311, 312 of the diaphragm 310 are connected to the rolling sleeve and upper spring seat 320, 550 by crimping rings 330, it will be appreciated that alternative securing arrangements are also intended to fall within the scope of this disclosure.

It will also be appreciated that the diaphragm is in fluid communication with a pneumatic system (not shown) where air is able to be supplied to and withdrawn from the air spring 300 in order to adjust the ride height of the vehicle.

The spring assembly 1 further comprises a bump rubber 560 and limiter 570 located around the piston rod 530. The bump rubber 560 is secured at the second end 532 of the piston rod 530 adjacent to the upper spring seat 550, and within the coil spring 100. The limiter 570 is secured to the top of the cylinder cap 540. It will be appreciated that the bump rubber and limiter 560, 570 act as bump stops in the event that the strut 400 is heavily compressed. It will be further appreciated that the bump rubber and limiter 560, 570 may bear against each other in the event of failure of the diaphragm 310 or associated pneumatic system.

It can also be seen that the strut 400 features a protective sleeve 600 which locates over the outside of the diaphragm 310, acting to protect the diaphragm 310 from accidental damage and to improve the working life and pressure rating of the diaphragm 310. The protecting sleeve 600 is also configured to be load bearing when the diaphragm 310 is inflated, preventing the diaphragm 310 from stretching or tearing due to over-inflation.

It will be appreciated that the above disclosure provides a means for instantaneously changing the spring rate of a spring assembly. It will further be appreciated that this adjustment in spring rate is achieved without requiring a change in the ride height of the vehicle.

While in the embodiments shown and described, the ride height of the vehicle may be adjusted by virtue of the third spring 300. It will be appreciated that in an alternate embodiment, the hydraulic actuator 210 may instead be selectively connected to a hydraulic fluid supply, such as a hydraulic pump (not shown) and reservoir (not shown), where hydraulic fluid may be supplied to and withdrawn from the actuator cylinder 211 in order to respectively increase and decrease the ride height of the vehicle.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A spring assembly for mounting between a chassis and an unsprung mass of a vehicle, the spring assembly comprising a coil spring and a hydropneumatic spring acting in series, wherein the hydropneumatic spring is configured to be switchable between a compressible state and an incompressible state, such that when the hydropneumatic spring is in the compressible state, the equivalent spring rate of the spring assembly is a function of the spring rate of the coil spring and the hydropneumatic spring, and when the hydropneumatic spring is in the incompressible state, the equivalent spring rate of the spring assembly is a function of the spring rate of the coil spring.

2. The spring assembly as claimed in claim 1, wherein the hydropneumatic spring comprises a hydraulic actuator in fluid communication with a hydraulic accumulator comprising a compressible volume of gas.

3. The spring assembly as claimed in claim 2, wherein the hydraulic actuator comprises an actuator cylinder and an actuator piston configured to move within the actuator cylinder in compression and rebound, wherein the actuator cylinder is filled with a hydraulic fluid and is in fluid communication with the hydraulic accumulator.

4. The spring assembly as claimed in claim 3, wherein the actuator cylinder is in selective fluid communication with the hydraulic accumulator by virtue of a switching valve, wherein the switching valve is switchable between an open and a closed state, corresponding to the compressible and incompressible state of the second spring.

5. The spring assembly as claimed in any one of the preceding claims, further comprising a third spring configured to act in parallel to the first and second spring acting in series.

6. A suspension strut for mounting between a chassis and an unsprung mass of a vehicle, the strut comprising a hydraulic damper, comprising a damper cylinder, a damper piston slidably retained within the damper cylinder and a piston rod for driving the piston within the damper cylinder in compression and rebound, the strut further comprising a spring assembly as described in any one of the preceding claims, attached with respect to the damper cylinder at a first end, and to the piston rod at a second end.
